(19) United States
(12) Patent Application Publication
(10) Pub. No.: US 2003/0005946 A1
(43) Pub. Date: Jan. 9, 2003

(54) Apparatus and method for cleaning a pipe

(76) Inventor: David Wayne Casella, Sorrento (AU)

Correspondence Address: MARGER JOHNSON & MCCOLLOM PC, 1030 SW MORRISON STREET, PORTLAND, OR, 97205, US

(21) Appl. No.: 09/959,052

(22) PCT Filed: Feb. 15, 2001
(86) PCT No.: PCT/AU01/00154

(30) Foreign Application Priority Data
Feb. 15, 2000 (AU) PQ 5655

(51) Int. Cl. B08B 9/055

(52) U.S. Cl. 134/8; 15/3.5

(57) ABSTRACT

A pipe cleaning apparatus adaptor assembley (1A) consists of an adaptor (2) arranged to be connected adjacent an opening (101) of a pipe (100) to be cleaned and a flange head plate (12) to close the opening (101) of the pipe (100). The flange head plate (12) has at least one opening (19) therein. The flange head plate (12) is releasably retained with the adaptor (2) by pins (7) received in apertures (13). The opening (19) of the flange head plate (12) is able to receive a supply of compressed air which is able to travel through the opening (101) of the pipe (100) and into the pipe (100). The flange head plate (12) is removable from the adaptor (2) so that, in use, a cleaning pellet (70) is insertable into the opening (101) of the pipe (100) and then the flange head plate (12) can be returned to close the opening (101) of the pipe (100) and again be retained with the adaptor (2). A cleaning apparatus (1) consisting of the pipe cleaning apparatus adaptor assembly (1A) and a pellet launcher (40) is also described. Air is discharged into the pipe (100) by the pellet launcher (40) via the opening (19) in the flange head plate (12).

### FIELD OF THE INVENTION

The present invention relates to a pipe cleaning apparatus adaptor assembly, an apparatus for cleaning a pipe and to a method for cleaning a pipe.

### DISCLOSURE OF THE INVENTION

In accordance with one aspect of the present invention there is provided a pipe cleaning apparatus adaptor assembly comprising adaptor means arranged to be connected adjacent an opening of a pipe to be cleaned, closure means to close said opening-of said pipe, said closure means having at least one opening therein, and retention means to releasably retain said closure means with said adaptor means, said at least one opening of said closure means arranged to receive, in use, a supply of compressed air which can then flow through the opening of the pipe and into the pipe, said closure means being removable from said adaptor means such that, in use, a cleaning pellet is insertible into the opening of the pipe and said closure means can be returned to close said opening of said pipe and again be retained with said adaptor means by said retention means.

Preferably, said adaptor means surrounds the opening of said pipe.

Preferably, said adaptor means is connectable to a flange of said pipe.

Preferably, said adaptor means is provided with seal means which is arranged to, in use, seal with a face of said flange of said pipe.

Preferably, said adaptor means is connectable to said flange by nuts and bolts.

In an alternative arrangement of said pipe, said adaptor means is connectable to said pipe by a screw-threaded connection.

Preferably, said retention means releasably retains said closure means with said adaptor means without a nut and bolt, screw-threaded or like connection therebetween.

Preferably, said retention means comprises first engagement means on said adaptor means and second engagement means on said closure means wherein said first and second engagement means are engagable.

Preferably, at least one hole is provided in said adaptor means and said closure means is provided with spring loaded pin means such that upon engagement of said first and second engagement means and said closure means being rotated to a second position, said spring loaded pin means is received in said at least one hole in said adaptor means.

Preferably, said first engagement means comprises pin means and said second engagement means comprises apertures, wherein said pin means are receivable in said apertures.

Alternatively, said first engagement means comprises apertures and said second engagement means comprises pin means, wherein said pin means are receivable in said apertures.

Preferably, said pin means are provided with heads and said apertures have respective first portions through which said heads of said pin means may pass and respective second portions through which said heads of said pin means are unable to pass such that after said pin means are received through said first portions of said apertures in a first position of said closure means, said closure means is rotatable to said second position such that said pin means are located in said second portions of said apertures.

Preferably, said closure means is provided with seal means which is arranged to, in use, seal with the inside surface of said adaptor means.

Preferably, said closure means is provided with a second opening therein arranged to receive a pressure gauge.

Preferably, said closure means is provided with a third opening therein arranged to receive pressure relief valve means.

Preferably, said closure means is provided substantially as a plate.

Preferably, said plate is provided with lug means and said apertures are provided in said lug means.

Preferably, said adapter means is provided as an annular disc.

In accordance with a second aspect of the present invention, there is provided a pipe cleaning apparatus comprising a pipe cleaning apparatus adaptor assembly as hereinbefore described and a pellet launcher operable to discharge compressed air therefrom, wherein said pellet launcher is arranged to be attached to said closure means such that, in use, the air that is discharged from said pellet launcher is supplied to said at least one opening of said closure means and flows into the pipe to force said pellet along the pipe to thereby clean the pipe.

In accordance with a third aspect of the present invention there is provided a method of cleaning a pipe comprising:

inserting pellet means into an opening of a pipe,

closing said opening of said pipe with closure means, and

injecting compressed air into said pipe through an opening in said closure means to force said pellet means along said pipe to thereby clean the interior of said pipe.

Preferably, the method further comprises connecting adaptor means adjacent said opening of said pipe and retaining said closure means with said adaptor means to close said opening of said pipe.

Preferably, the method further comprises connecting said adaptor means to a flange of said pipe which surrounds said opening of said pipe.

Preferably, the method further comprises retaining said closure means with said adaptor means without use of a nut and bolt, screw-threaded or other like means.

Preferably, the method further comprises retaining said closure means with said adaptor means by engaging first and second engagement means of said adaptor means and said closure means, respectively, turning said closure means relative to said adaptor means and locating a pin of said closure means in a hole of said adaptor means.

Preferably, the method further comprises attaching a supply of compressed air to said closure means and injecting compressed air through at least one opening in said closure means and said opening of said pipe and into said pipe to force said pellet along said pipe.

### BRIEF DESCRIPTION OF THE DRAWINGS

The present invention will now be described, by way of example, with reference to At the accompanying drawings, in which:

FIG. 1 is an exploded perspective view of an embodiment of the pipe cleaning apparatus of the present invention showing its attachment to a pipe to be cleaned;

FIG. 2 is an exploded perspective view of the first stage of attachment of the pipe cleaning apparatus shown in FIG. 1 to a pipe to be cleaned;

FIG. 3 is a perspective view showing the adaptor in position on the flange of the pipe to be cleaned;

FIG. 4 is a perspective view showing the flange head plate in position to be retained by the adaptor which together form the pipe cleaning apparatus adaptor assembly, and with the pellet launcher attached to the flange head plate;

FIG. 5 is a perspective view showing the pipe cleaning apparatus shown in FIG. 1 in place on a pipe to be cleaned;

FIG. 6 is a perspective view of the inside face of the flange head plate of the pipe cleaning apparatus shown in FIG. 1;

FIG. 7 is a side view of the flange head plate shown in FIG. 6.

### BEST MODE(S) FOR CARRYING OUT THE INVENTION

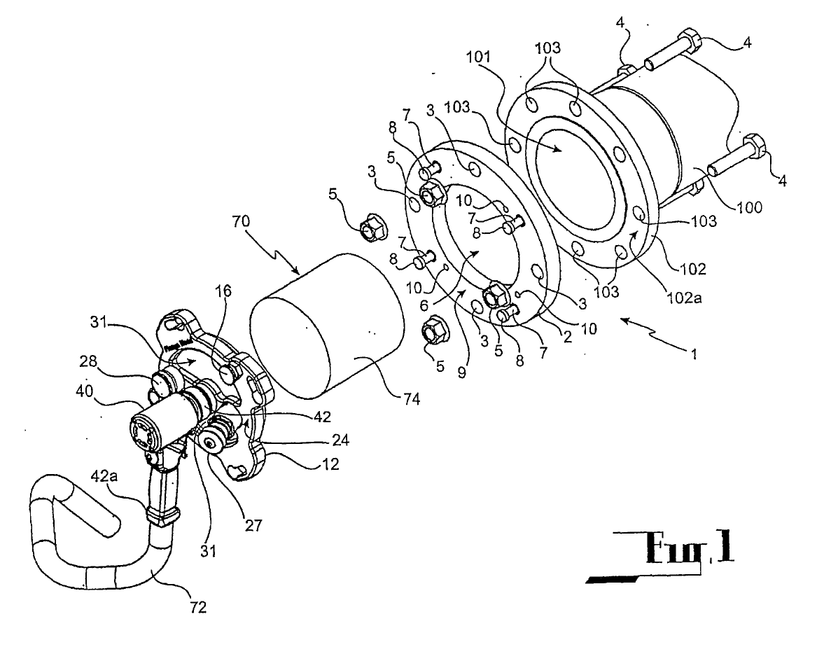

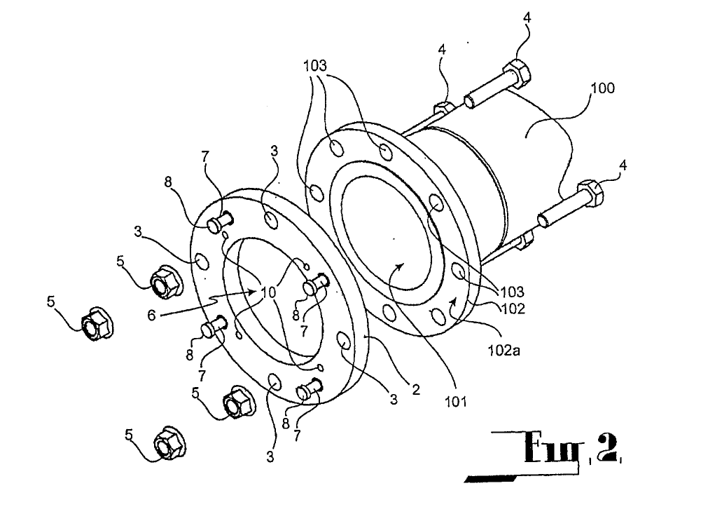

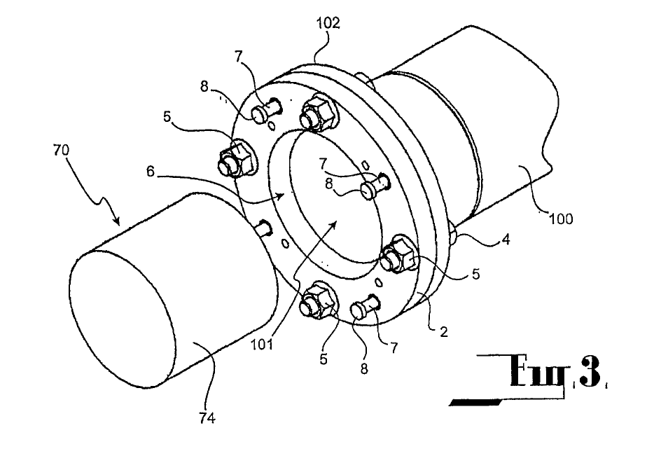

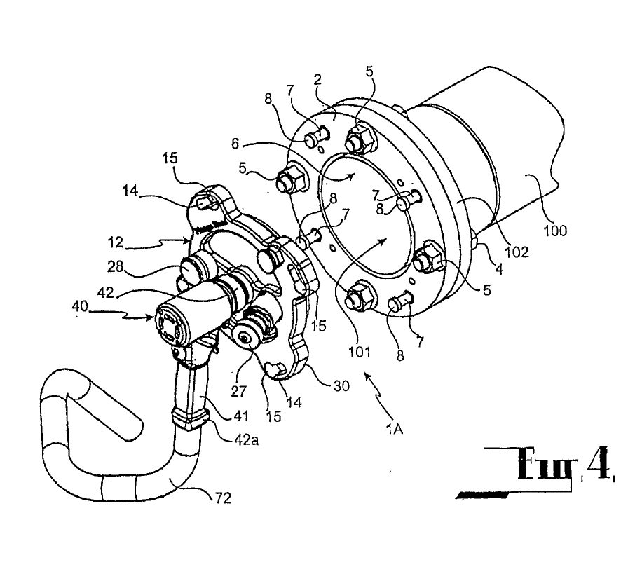

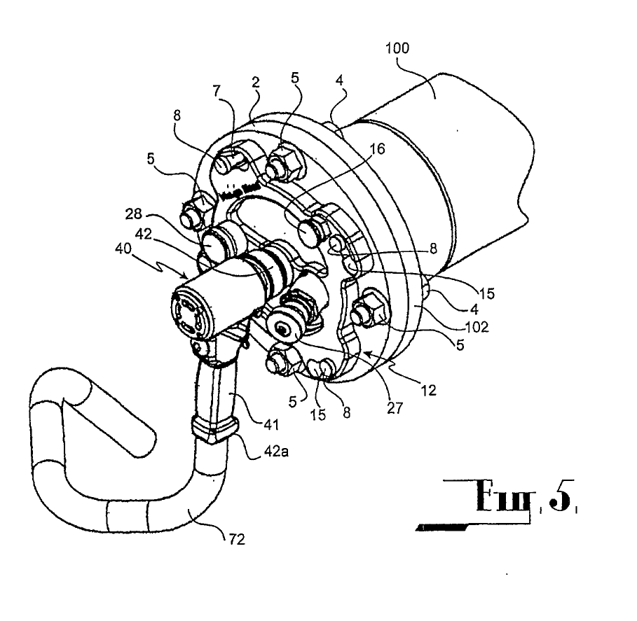

In FIG. 1 there is shown an apparatus 1 for cleaning a pipe 100. The pipe 100 has an opening 101 and a flange 102 surrounding the opening 101. The flange 102 is provided with apertures 103 which may be used to connect the pipe 100 to other pipes 100 by way of bolts passing through the apertures 103 which are secured by nuts.

The apparatus 1 comprises a pipe cleaning apparatus adaptor assembly 1A and a projectile launcher or pellet launcher 40.

The pipe cleaning apparatus adaptor assembly IA comprises an adaptor 2 and a flange head closure plate 12 (also referred to herein as a flange head plate).

The adaptor 2 is arranged to be connected adjacent the opening 101 of the pipe 100. The adaptor 2 surrounds the opening 101 of the pipe 100. The adaptor 2 is provided with apertures 3 therein. The adaptor 2 can be connected with the flange 102 of the pipe 100 by passing bolts 4 through the apertures 103 of the flange 102 and the apertures 3 of the adaptor 2 and securing them with nuts 5. In this way, the adaptor 2 can be rigidly connected to the flange 102 of the pipe 100. The adaptor 2 is disc shaped and has an opening 6 therein. In this way, the adaptor 2 is of annular form. The opening 6 is substantially the same size as, or slightly larger than, the opening 101 of the pipe 100. The opening 6 overlies the opening 101. One face of the adaptor 2 thus abuts with the surface 102a of the flange 102. A seal (obscured in the drawings) is provided on the face of the adaptor 2 that abuts with the surface 102a of the flange 100. This seal may, for example, be provided as an O-ring.

However, in the case of pipes 100 not having a flange 102, the adaptor 2 may be connected by other suitable means, e.g. a screw-threaded connection.

The adaptor 2 is provided with pins 7 extending from the second face 9 thereof.

The second face 9 of the adaptor 2 is also provided with holes 10. The holes 10 do not extend through to the first face of the adaptor 2.

The flange head plate 12 is provided with apertures 13.

The apertures 13 have a first portion 14 and a second portion 15. The first portions 14 are large enough for the heads 8 of the pins 7 to pass therethrough. The portions 15 are smaller and the heads 8 are unable to pass therethrough.

The flange head plate 12 is provided with a spring loaded pin 16. The spring loaded pin 16 extends through the flange head plate 12 via an aperture 17 provided in the flange head plate 12. The spring loaded pin 16 is spring loaded such that it is biased to extend through the aperture 17 to project beyond the (inner) face 18 of the flange head plate 12 which lies adjacent the second surface 9 of the adaptor 2 when held thereby. The tip 16a of the pin 16 can be seen projecting from the aperture 17 beyond the surface 18 in FIG. 7.

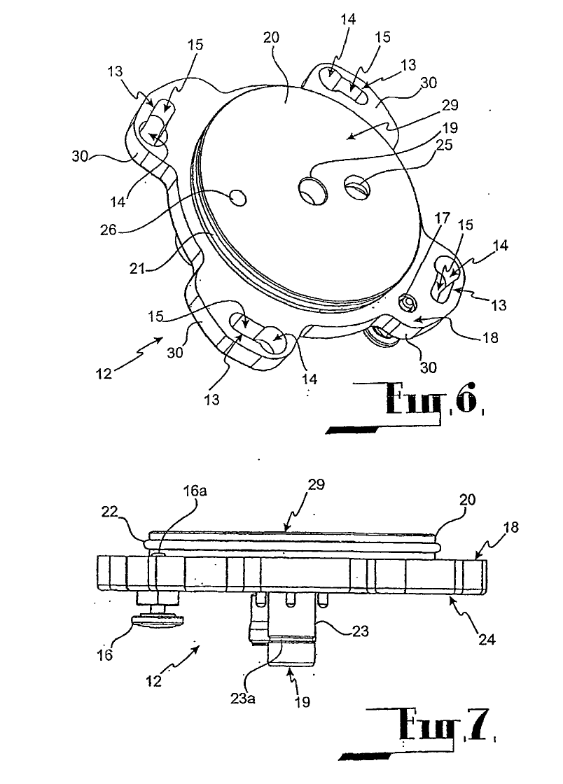

The flange head plate 12 is provided with an opening 19 therein which extends through the flange head plate 12. A spigot 20 is provided adjacent the face 18 of the flange head plate 12. The spigot 20 has a groove 21 (shown in FIG. 6) therein to receive an O-ring 22 (shown in FIG. 7). The diameter of the spigot 20 is slightly less than the inside diameter of the adaptor 2 at the opening 6 so that it can be received into the opening 6 and the seal 22, being of a slightly greater diameter, forms a seal with the inside surface of the adaptor 2 at the opening 6.

A connection fitting 23 extends from the outer face 24 of the flange head plate 12. The opening 19 extends through the connection fitting 23. The connection fitting 23 is provided with a circumferential groove 23a therein. The pellet launcher 40 is attachable to the flange head plate 12 byway of the circumferential groove 23a of connection fitting 23.

The flange head plate 12 is provided with two further openings 25 and 26 therein.

The opening 25 is arranged to receive a pressure relief valve 27 and the opening 26 is arranged to receive a pressure gauge 28. The pressure relief valve 27 is able to relieve pressure in the pipe 100 if required.

The openings 19, 25 and 26 extend from the outer face 24 of the flange head plate 12 to the planar surface 29 of the spigot 20.

The apertures 13 are provided in lugs 30 of the flange head plate 12.

The pellet launcher 40 is provided with a handle 41 to, in use, be held by an operator and a connector 42 for connection to the connector 23 of the flange head plate 12.

The pellet launcher 40 is pistol-like in appearance.

The connection provided by the connection fitting 23 and connector 42 may be a quick release coupling (which is of known form) that forms an air tight connection seal between the pellet launcher 40 and the flange head plate 12. The connector 42 is provided with bearings which locate in the circumferential groove 23a of the connection fitting 23. The connector 42 is in the form of a collar. Rotating the connector 42 engages and tightens the bearings in the circumferential groove 23a to form a tight connection seal.

The pellet launcher 40 is provided with a trigger 43. An air inlet 42a is provided at the base of the handle 41. The pellet launcher 40 is provided with an outlet into which the connection fitting 23 is received. An airflow path extends from the inlet 42a to the outlet of the pellet launcher 40. A valve mechanism is contained within the pellet launcher 40 to control airflow therethrough. The valve mechanism is activated by squeezing the trigger 43. A hose 72 from a compressed air source is attached to the inlet 42a. Squeezing the trigger 43 opens the valve mechanism in the pellet launcher 40 and allows air to flow through the airflow passage in the pellet launcher 40. The compressed air is then ejected form the outlet of the pellet launcher 40 and is injected into the opening 101 of the pipe 100.

The method of operation and use of the apparatus of the present invention will now be described.

In use, the adaptor 2 is connected to the flange 102 of a pipe 100 as previously hereinbefore described. A cleaning pellet 70 is then inserted into the pipe 100 via the opening 101. The cleaning pellet 70 is larger than the internal diameter of the pipe 100. Preferably, the cleaning pellet 70 has a diameter substantially 10% greater than the internal diameter of the pipe 100. The cleaning pellet 70 is, however, made of compressible and resilient material so that it can be pushed into the pipe 100. For example, the cleaning pellet 70 may be made of foam. The cleaning pellet 70 may also be provided with abrasive qualities, e.g. by abrasives being formed with the foam at the time of manufacture of the cleaning pellet 70. Furthermore, the cleaning pellet 70 may be coated with cleaning solution prior to insertion into the pipe 100.

Following insertion of the cleaning pellet 70 into the pipe 100, the flange head plate 12 is fitted to the adaptor 2 such that it is releasably retained in place by the adaptor 2.

This is done by aligning the heads 8 of the pins 7 with the portions 14 of the apertures 13 and then fitting the flange head plate 12 to the adaptor 2 such that the heads 8 extend through the portions 14 of the apertures 13 to the front face 24 of the flange head plate 12. The flange head plate 12 is then turned, i.e. rotated, so that the pins 7 are received in the portions 15 of the apertures 13. As the flange head plate 12 is turned, the spring loaded pin 16, whose tip 16a abuts with the second face 9 of the adaptor 2, is biased into one of the holes 10.

The location of the spring loaded pin 16 in one of the holes 10 prevents turning of the flange head plate 12. In addition, the thickness of the flange head plate 12 is substantially the same as the distance between the heads 8 of the pins 7 and the second surface 9 of the adaptor 2. Since the heads 8 of the pins 7 are larger than the portions 15 of the apertures 13, any movement of the flange head plate 12 in the axial direction of the pipe 100 is prevented.

In the above described manner, the flange head plate 12 is securely releasably retained with the adaptor 2. Furthermore, it is retained without any bolting, screwing or like connections. Thus, the flange head plate 12 is securely retained with the adaptor 2 but is easily removable therefrom.

To remove the flange head plate 12, the spring loaded pin 16 is pulled outwardly and the flange head plate 12 is rotated until the heads 8 are aligned with the portions 14 of the apertures 13. The flange head plate 12 can then readily be pulled away from the adaptor 2.

The pellet launcher 40 is attached to the flange head plate 12 via the quick release coupling previously hereinbefore described. A hose 72 is attached to the inlet 42a of the pellet launcher 40. The other end of the hose 72 is attached to a compressed air source.

Squeezing the trigger 43 allows air to flow through the pellet launcher 40 from the inlet 42a to the outlet, as previously hereinbefore described The air is injected through the opening 19 in the flange head plate 12 and flows into the pipe 100 via the opening 101. The compressed air forces the cleaning pellet 70 along the pipe 100.

Since the diameter of the cleaning pellet 70 is greater than the inside diameter of the pipe 100, the surface 74 of the cleaning pellet 70 is in tight contact with the internal surface of the pipe 100 and removes debris and other material adhering to the internal surface of the pipe 100.

The cleaning pellet 70 travels through the pipe 100 and exits at the other end of the pipe 100.

Should the cleaning pellet 70 encounter an obstruction in the pipe 100 which impedes its further passage, the flow of air to the pipe 100 can be interrupted and the flange head plate 12 removed. An adaptor 2 can be connected to a flange 102 at the other end of the pipe 100 and the cleaning pellet 70 forced back through the pipe 100 in the reverse direction. The cause of the obstruction can then be investigated and appropriate action taken.

The apparatus 1 of the present invention can also be used to clean pipes have T or Y joints therein. In such pipe configurations, the pipe passage along which it is desired that the cleaning pellet 70 travels, can be left open whilst the other passage is blocked off using any suitable means. The cleaning pellet 70 will then travel along the passage having a free opening. Once that passage has been cleaned, it can be blocked off and the other passage opened for a cleaning pellet 70 to be forced through the pipe 100 to travel through the other passage.

The flange head plate 12 can be readily removed from the adaptor 2 to insert another cleaning pellet 70 into the pipe 100 if required. The flange head plate 12 can then readily be retained with the adaptor 2, as previously hereinbefore described, and the second cleaning pellet 70 forced along the pipe 100 by the compressed air.

The apparatus 1 of the present invention enables the use of compressed air to be used to clean pipes using cleaning pellets whilst providing an arrangement whereby access to the interior of the pipe 100 can be readily achieved by removal of the flange head plate 12 from the adaptor 2. The use of air also avoids disadvantages of prior art systems which employ liquids since discharge of the liquids from the other end of the pipe must be contained.

Compressed air at a pressure of, for example, 100 psi may be used. However, other pressures, both less and greater may also be used.

Modifications and variations such as would be apparent to a skilled addressee are deemed to be within the scope of the present invention.

Throughout the specification, unless the context requires otherwise, the word “comprise” or variations such as “comprises” or “comprising”, will be understood to imply the inclusion of a stated integer or group of integers but not the exclusion of any other integer or group of integers.

1. A pipe cleaning apparatus adaptor assembly characterised in that it comprises adaptor means arranged to be connected adjacent an opening of a pipe to be cleaned, closure means to close said opening of said pipe, said closure means having at least one opening therein, and retention means to releasably retain said closure means with said adaptor means, said at least one opening of said closure means arranged to receive, in use, a supply of compressed air which can then flow through the opening of the pipe and into the pipe, said closure means being removable from said adaptor means such that, in use, a cleaning pellet is insertible into the opening of the pipe and said closure means can be returned to close said opening of said pipe and again be retained with said adaptor means by said retention means.

2. A pipe cleaning apparatus adaptor assembly according to claim 1, characterised in that said adaptor means surrounds the opening of said pipe.

3. A pipe cleaning apparatus adaptor assembly according to claim 1 or 2, characterised in that said adaptor means is connectable to a flange of said pipe.

4. A pipe cleaning apparatus adaptor assembly according to any one of the preceding claims, characterised in that said adaptor means is provided with seal means which is arranged to, in use, seal with a face of said flange of said pipe.

5. A pipe cleaning apparatus adaptor assembly according to any one of the preceding claims, characterised in that said adaptor means is connectable to said flange by nuts and bolts.

6. A pipe cleaning apparatus adaptor assembly according to any one of the preceding claims, characterised in that said adaptor means is connectable to said pipe by a screw-threaded connection.

7. A pipe cleaning apparatus adaptor assembly according to any one of the preceding claims, characterised in that said retention means releasably retains said closure means with said adaptor means without a nut and bolt, screw-threaded or like connection therebetween.

8. A pipe cleaning apparatus adaptor assembly according to any one of the preceding claims, characterised in that said retention means comprises first engagement means on said adaptor means and second engagement means on said closure means wherein said first and second engagement means are engagable.

9. A pipe cleaning apparatus adaptor assembly according to claim 8, characterised in that at least one hole is provided in said adaptor means and said closure means is provided with spring loaded pin means such that upon engagement of said first and second engagement means and said closure means being rotated to a second position, said spring loaded pin means is received in said at least one hole in said adaptor means.

10. A pipe cleaning apparatus adaptor assembly according to claim 8 or 9, characterised in that said first engagement means comprises pin means and said second engagement means comprises apertures, wherein said pin means are receivable in said apertures.

11. A pipe cleaning apparatus adaptor assembly according to claim 8 or 9, characterised in that said first engagement means comprises apertures and said second engagement means comprises pin means, wherein said pin means are receivable in said apertures.

12. A pipe cleaning apparatus adaptor assembly according to claim 10 or 11, characterised in that said pin means are provided with heads and said apertures have respective first portions through which said heads of said pin means may pass and respective second portions through which said heads of said pin means are unable to pass such that after said pin means are received through said first portions of said apertures in a first position of said closure means, said closure means is rotatable to said second position such that said pin means are located in said second portions of said apertures.

13. A pipe cleaning apparatus adaptor assembly according to any one of the preceding claims, characterised in that said closure means is provided with seal means which is arranged to, in use, seal with the inside surface of said adaptor means.

14. A pipe cleaning apparatus adaptor assembly according to any one of the preceding claims, characterised in that said closure means is provided with a second opening therein arranged to receive a pressure gauge.

15. A pipe cleaning apparatus adaptor assembly according to any one of the preceding claims, characterised in that said closure means is provided with a third opening therein arranged to receive pressure relief valve means.

16. A pipe cleaning apparatus adaptor assembly according to any one of the preceding claims, characterised in that said closure means is provided substantially as a plate.

17. A pipe cleaning apparatus adaptor assembly according any one of the preceding claims, characterised in that said plate is provided with lug means and said apertures are provided in said lug means.

18. A pipe cleaning apparatus adaptor assembly according to any one of the preceding claims, characterised In that said adaptor means is provided as an annular disc.

19. A pipe cleaning apparatus comprising a pipe cleaning apparatus adaptor assembly as hereinbefore described and a pellet launcher operable to discharge compressed air therefrom, wherein said pellet launcher is arranged to be attached to said closure means such that, in use, the air that is discharged from said pellet launcher is supplied to said at least one opening of said closure means and flows into the pipe to force said pellet along the pipe to thereby clean the pipe.

20. A method of cleaning a pipe comprising:
inserting pellet means into an opening of a pipe,
closing said opening of said pipe with closure means, and
injecting compressed air into said pipe through an opening in said closure means to force said pellet means along said pipe to thereby clean the interior of said pipe.

21. A method according to claim 20, characterised in that the method further comprises connecting adaptor means adjacent said opening of said pipe and retaining said closure means with said adaptor means to close said opening of said pipe.

22. A method according to claim 20 or 21, characterised in that the method further comprises connecting said adaptor means to a flange of said pipe which surrounds said opening of said pipe.

23. A method according to any one of the preceding claims, characterised in that the method further comprises retaining said closure means with said adaptor means without use of a nut and bolt, screw-threaded or other like means.

24. A method according to any one of the preceding claims, characterised in that the method further comprises retaining said closure means with said adaptor means by engaging first and second engagement means of said adaptor means and said closure means, respectively, turning said closure means relative to said adaptor means and locating a pin of said closure means in a hole of said adaptor means.

25. A method according to any one of the preceding claims, characterised in that the method further comprises attaching a supply of compressed air to said closure means and injecting compressed air through at least one opening in said closure means and said opening of said pipe and into said pipe to force said pellet along said pipe.
